(19) United States
(12) Patent Application Publication
(10) Pub. No.: US 2025/0300719 A1
(43) Pub. Date: Sep. 25, 2025

(54) COMMUNICATION SYSTEM, BASE STATION APPARATUS, AND METHOD FOR CONTROLLING COMMUNICATION SYSTEM

(71) Applicant: NEC Corporation, Tokyo (JP)

(72) Inventor: Takuji MOCHIZUKI, Tokyo (JP)

(73) Assignee: NEC Corporation, Tokyo (JP)

(21) Appl. No.: 19/077,301

(22) Filed: Mar. 12, 2025

(30) Foreign Application Priority Data
Mar. 21, 2024 (JP) 2024-045354

(51) Int. Cl. H04B 7/06; H04B 17/21

(52) U.S. Cl. CPC H04B 7/0697; H04B 17/21

(57) ABSTRACT

A communication system according to the present disclosure includes: a base station apparatus including a plurality of Active Antenna Systems (AASs); and a management apparatus configured to be able to communicate with each of the plurality of AASs, in which the management apparatus is configured to notify each of the plurality of AASs of a common time and an Identification (ID) that is unique to each of the plurality of respective AASs, and each of the AASs is configured to perform downlink and uplink calibration within a predetermined period from a predetermined time that is defined by the common time and is periodically set in accordance with the ID allocated to each of the AASs.

### INCORPORATION BY REFERENCE

This application is based upon and claims the benefit of priority from Japanese patent application No. 2024-045354, filed on Mar. 21, 2024, the disclosure of which is incorporated herein in its entirety by reference.

### TECHNICAL FIELD

The present disclosure relates to a communication system, a base station apparatus, and a method for controlling a communication system.

### BACKGROUND ART

The number of AAS stations in which a full digital beamforming method capable of achieving high frequency utilization efficiency for a 5G super multi-element active antenna system (AAS) is employed and communication is performed using a frequency band equal to or lower than Sub-6 GHz whose propagation performance for mobile applications in 5G is better than that of millimeter waves while pursuing spatial multiplexing performance by Massive MIMO has been increasing.

However, even when Sub-6 GHz is used, its propagation performance is lower than that of a Low band (around 800 MHZ, sometimes referred to as a platinum/premium frequency band). Therefore, in order to expand area coverage of Sub-6 GHz while maintaining stable communication performance, it becomes important to design station installation in which blind zones are eliminated, like in LTE, by iteratively deploying a plurality of base station apparatuses each having a three-sector configuration (a configuration that uses three AASs) that cover a 360 degree horizontal direction in a plane. Techniques related to the communication system are disclosed, for example, in Patent Literature 1 and 2.
[Patent Literature 1] Published Japanese Translation of PCT International Publication for Patent Application, No. 2020-507286
[Patent Literature 2] Published Japanese Translation of PCT International Publication for Patent Application, No. 2006-515141

### SUMMARY

However, there is a problem, in a base station apparatus including a plurality of AASs in the communication systems disclosed in the related art, that the accuracy of calibration of each AAS is degraded due to interference by a Downlink Calibration (DL CAL) signal of each AAS with an Uplink Calibration (UL CAL) signal of another AAS that is adjacent to the above AAS, which causes the communication quality to be degraded.

An object of the present disclosure is to provide a communication system, a base station apparatus, and a method for controlling a communication system that solve the aforementioned problem.

A communication system according to the present disclosure includes: a base station apparatus including a plurality of Active Antenna Systems (AASs); and a management apparatus configured to be able to communicate with each of the plurality of AASs, in which the management apparatus is configured to notify each of the plurality of AASs of a common time and an Identification (ID) that is unique to each of the plurality of respective AASs, and each of the AASs is configured to perform downlink and uplink calibration within a predetermined period from a predetermined time that is defined by the common time and is periodically set in accordance with the ID allocated to each of the AASs.

A base station apparatus according to the present disclosure includes: a plurality of Active Antenna Systems (AASs), in which each of the AASs is configured to perform downlink and uplink calibration within a predetermined period from a predetermined time that is defined by a common time sent to the plurality of AASs and is periodically set in accordance with an ID allocated to each of the AASs.

A method for controlling a communication system according to the present disclosure is a method for controlling a communication system including a base station apparatus including a plurality of Active Antenna Systems (AASs); and a management apparatus configured to be able to communicate with each of the plurality of AASs, in which the management apparatus notifies each of the plurality of AASs of a common time and an Identification (ID) that is unique to each of the plurality of respective AASs, and in each of the AASs, downlink and uplink calibration is performed within a predetermined period from a predetermined time that is defined by the common time and is periodically set in accordance with the ID allocated to each of the AASs.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a schematic top view of a base station apparatus according to the present disclosure;

FIG. 2 is a schematic perspective view of the base station apparatus according to the present disclosure;

FIG. 3 is a diagram showing an example of the arrangement of the base station apparatus according to the present disclosure;

FIG. 4 is a diagram for describing a problem of a base station apparatus formed of a plurality of AASs;

FIG. 5 is a diagram for describing a problem of the base station apparatus formed of the plurality of AASs;

FIG. 6 shows a configuration example of a communication system according to the present disclosure;

FIG. 7 is a timing chart showing an operation of the base station apparatus according to the present disclosure;

FIG. 8 is a timing chart showing a further detail of a part of the operation of the base station apparatus according to the present disclosure;

FIG. 9 is a timing chart showing a further detail of a part of the operation of the base station apparatus according to the present disclosure;

FIG. 10 is a timing chart showing a further detail of a part of the operation of the base station apparatus according to the present disclosure; and

FIG. 11 is a block diagram showing one example of a hardware configuration for implementing some or all of communication control functions of the communication system according to the present disclosure.

### EXAMPLE EMBODIMENT

Example embodiments of the present disclosure will be described below with reference to the accompanying drawings. Note that the drawings are in simplified form and the technical scope of the example embodiments should not be narrowly interpreted to be limited to the drawings. The same elements are denoted by the same reference numerals and a duplicate description is omitted.

In the following example embodiments, when necessary, the present disclosure is explained by using separate sections or separate example embodiments. However, those example embodiments are not unrelated with each other, unless otherwise specified. That is, they are related in such a manner that one example embodiment is a modified example, an application example, a detailed example, or a supplementary example of a part or the whole of another example embodiment. Further, in the following example embodiments, when the number of elements or the like (including numbers, values, quantities, ranges, and the like) is mentioned, the number is not limited to that specific number except for cases where the number is explicitly specified or the number is obviously limited to a specific number based on its principle. That is, a larger number or a smaller number than the specific number may also be used.

Further, in the following example embodiments, the components (including operation steps and the like) are not necessarily indispensable except for cases where the component is explicitly specified or the component is obviously indispensable based on its principle. Similarly, in the following example embodiments, when a shape, a position relation, or the like of a component(s) or the like is mentioned, shapes or the like that are substantially similar to or resemble that shape are also included in that shape except for cases where it is explicitly specified or they are eliminated based on its principle. This is also true for the above-described number or the like (including numbers, values, quantities, ranges, and the like).

### First Example Embodiment

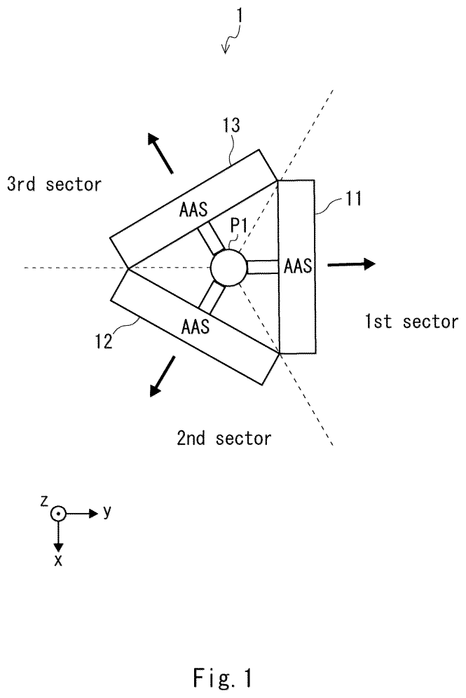

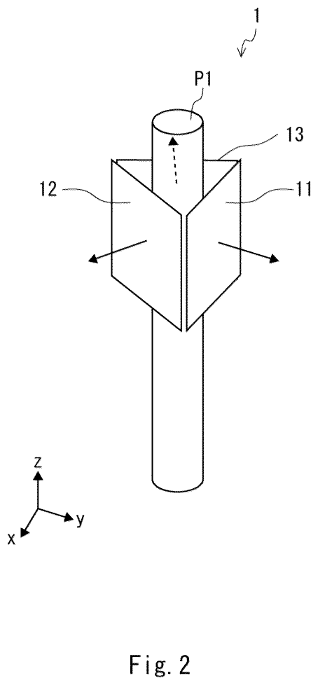

FIG. 1 is a schematic top view of a base station apparatus 1 according to the present disclosure. Further, FIG. 2 is a schematic perspective view of the base station apparatus 1 according to the present disclosure.

The base station apparatus 1, which includes a spatial multiplexing function by Massive-MIMO (MU-MIMO), is configured to be able to perform communication by digital beamforming. Specifically, the base station apparatus 1 includes three flat AASs 11-13 provided to surround a pole P1. That is, in the base station apparatus 1, a three-sector configuration in which each of the three AASs 11-13 covers 120 degrees (azimuth angle ±60 degrees) of the 360 degree horizontal direction is employed.

Each of the AASs 11-13 includes a plurality of antenna elements arranged in a matrix and a plurality of transceivers provided so as to correspond to the respective antenna elements. For example, in each of the AASs 11-13, two sets of antenna groups, each formed of two antenna elements arranged along a vertical direction (z-axis direction), are arranged along the vertical direction, and eight sets of the same antenna groups are arranged along a horizontal direction (a direction on the xy plane). Further, two stages of flat antenna arrays, each formed of an antenna group of 2×8 sets (that is, 4×8 antenna elements) are stacked on each other. Of the antenna arrays of two stages, the antenna array arranged in the front (outer side) is a −45 degree polarized antenna, whereas the antenna array arranged in the back (inner side) is a ±45 degree polarized antenna. These antenna arrays of two stages form ±45 degree orthogonal polarization shared antenna. Further, a transceiver is provided for each antenna group. That is, each of the AASs 11-13 includes 32 sets of antenna groups (64 antenna elements) and 32 transceivers.

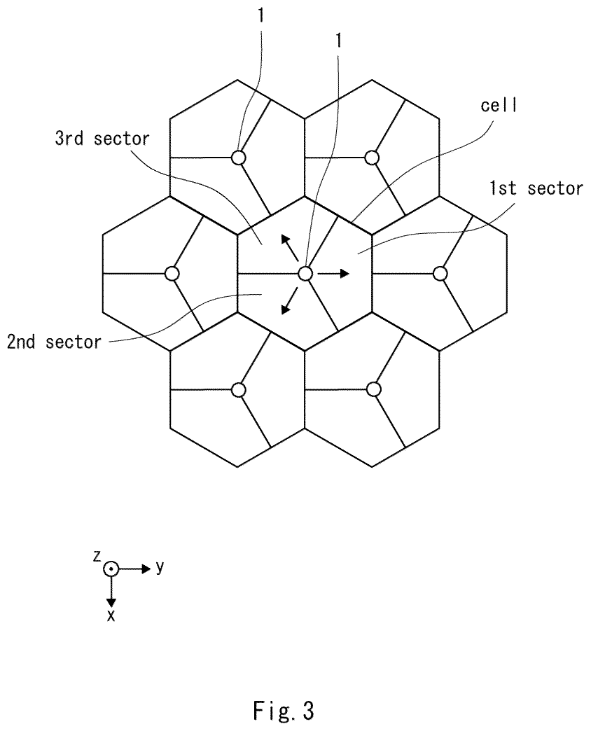

FIG. 3 is a diagram showing an example of the arrangement of the base station apparatus 1. As shown in FIG. 3, the base station apparatus 1 having a three-sector configuration that covers the 360 degree horizontal direction is arranged repeatedly in a plane. It is therefore possible to design a station installation having no blind zones.

Each of the AASs 11-13 is configured to carry out DL CAL and UL CAL periodically. DL CAL is an abbreviation for Downlink Calibration. UL CAL is an abbreviation for Uplink Calibration. DL CAL and UL CAL may be collectively referred to as DL/UL CAL. Each of the AASs 11-13 carries out DL/UL CAL, thereby performing processing for matching amplitude-phase-frequency characteristics of all the transceivers (TRXs) provided in the AAS.

However, in a typical base station apparatus having a three-sector configuration, there is a problem that, due to interference by DL CAL signals radiated and leaked outside the antennas of each AAS with UL CAL signals of antennas of the AAS adjacent to the above AAS (leakage of the CAL signals and re-coupling to the adjacent AAS antenna), the accuracy of the UL CAL in each AAS is degraded, resulting in a degradation in the communication quality. Note that DL/UL CAL signals are signals transmitted or received in each AAS within a Transmit On/Off Period (e.g., 10 microseconds) in the time before and after the DL Slot.

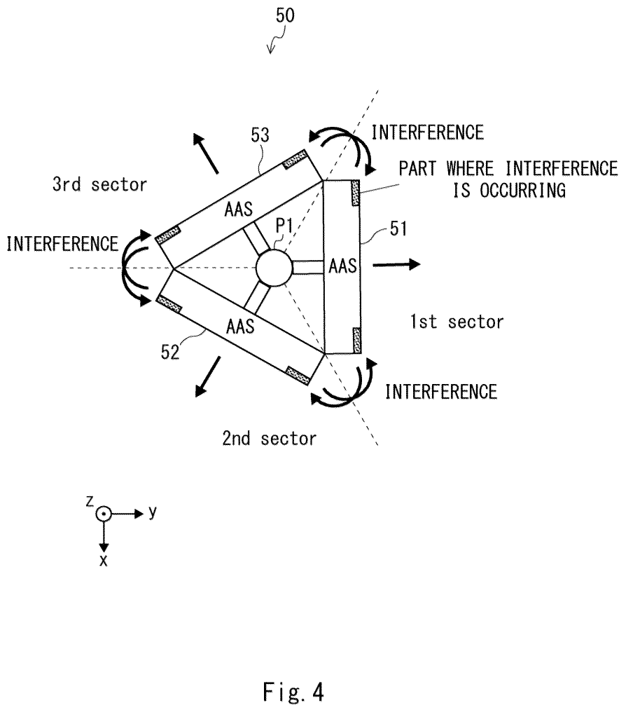

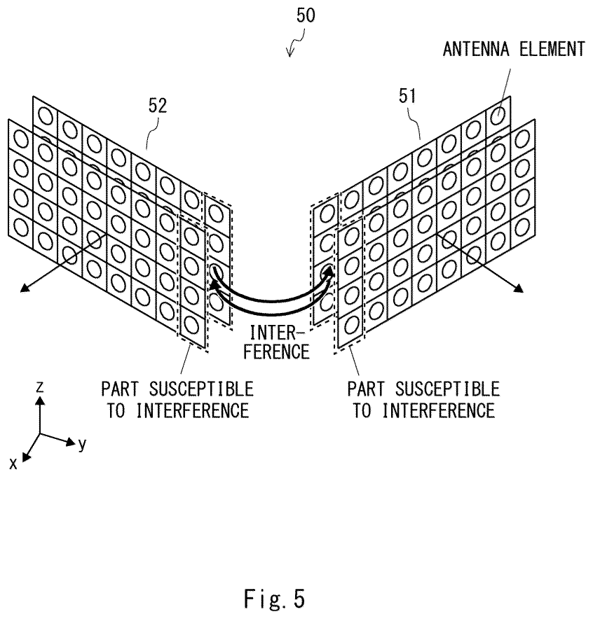

FIGS. 4 and 5 are diagrams each describing a problem of a general base station apparatus 50 formed of three AASs 51-53. In the diagram shown in FIG. 5, of the three AASs 51-53, only two representative AASs 51 and 52 are shown. The AASs 51-53 respectively correspond to the AASs 11-13, and the basic structure of the AASs 51-53 is similar to that of the AASs 11-13.

As shown in FIGS. 4 and 5, the UL CAL signal of each of the AASs 51 and 52 that are adjacent to each other is interfered with by a DL CAL signal of the other AAS. Likewise, the UL CAL signal of each of the AASs 52 and 53 that are adjacent to each other is interfered with by a DL CAL signal of the other AAS. Likewise, the UL CAL signal of each of the AASs 53 and 51 that are adjacent to each other is interfered with by a DL CAL signal of the other AAS.

For example, in the base station apparatus 50, based on a 1 Pulse Per Second (PPS) signal that a Central Unit (CU) or a Distributed Unit (DU), which is an apparatus whose order is higher than that of a Radio Unit (RU; that is, AAS), has received from a GPS (GNSS) satellite, and a reference clock signal of about 10 MHz generated based on the 1 PPS signal after each of the AASs 51-53 is started up, a DL/UL TDD timing from the DU to each of the AASs 51-53 is synchronized. Note that the GPS is an abbreviation for Global Positioning System. GNSS is an abbreviation for Global Navigation Satellite System. The synchronization performed here is, for example, synchronization by Precision Time Protocol (PTP). Here, DL/UL CAL is performed within a Transmit On/Off Period (e.g., 10 microseconds), which corresponds to the time before and after the DL Slot after the completion of the TRX set in each of the AASs 51-53. However, in each of the AASs 51-53, CAL circulation is started by a start-up instruction sent from Middleware to RF Software, whereby the DL/UL CAL sequence of DL/UL CAL is carried out asynchronously in a cyclic manner. Therefore, in the base station apparatus 50, due to interference by asynchronous DL CAL signals radiated and leaked outside the antennas of each of the AASs 51-53 with UL CAL signals of antennas of the AAS adjacent to the above AAS, the accuracy of the UL CAL in each of the AASs 51-53 is degraded, resulting in a degradation in the communication quality.

In order to solve the above problems, in the base station apparatus 1 according to the present disclosure, each of the AASs 11-13 is configured to carry out DL/UL CAL within a predetermined period after a predetermined time periodically set in accordance with an allocated unique ID. The unique ID is, for example, the number of the sector managed by the AASs 11-13, and is sent from the DU to each of the AASs 11-13 via an optical fronthaul. Accordingly, each of the AASs 11-13 recognizes the unique ID such as a sector number. Further, the predetermined time set in each of the AASs 11-13 is defined by a common time such as an absolute time sent from the DU to each of the AASs 11-13. The common time such as the absolute time is PTP-synchronized based on, for example, a 1 PPS signal that a high-order apparatus such as an RU has received from the GPS (GNSS) and a reference clock signal generated based on the 1 PPS signal.

For example, the AAS 11 carries out DL/UL CAL within a predetermined period Taas1 from a time t11 set in accordance with the allocated unique ID (e.g., sector number 1). The AAS 12 carries out DL/UL CAL within a predetermined period Taas2 from a time t12 set in accordance with the allocated unique ID (e.g., sector number 2). The AAS 13 carries out DL/UL CAL within a predetermined period Taas3 from a time t13 set in accordance with the allocated unique ID (e.g., sector number 3). The time t11, t12, and t13 are PTP-synchronized based on the 1 PPS signal received from the GPS (GNSS) and a reference clock signal generated based on the 1 PPS signal, and are defined by a common time such as an absolute time sent to the AASs 11-13 via the DU. Then the AASs 11-13 set a predetermined time t11 and a predetermined period Taas1, a predetermined time t12 and a predetermined period Taas2, and a predetermined time t13 and a predetermined period Taas3, respectively, in such a way that the time zone of the predetermined period Taas1 from the time t11, the time zone of the predetermined period Taas2 from the time t12, and a time zone of the predetermined period Taas3 from the time t13 do not overlap each other.

Accordingly, the base station apparatus 1 according to the present disclosure is able to accurately perform DL/UL CAL in each of the AASs 11-13 without interferences from the neighboring AAS, thereby enabling high-quality communication.

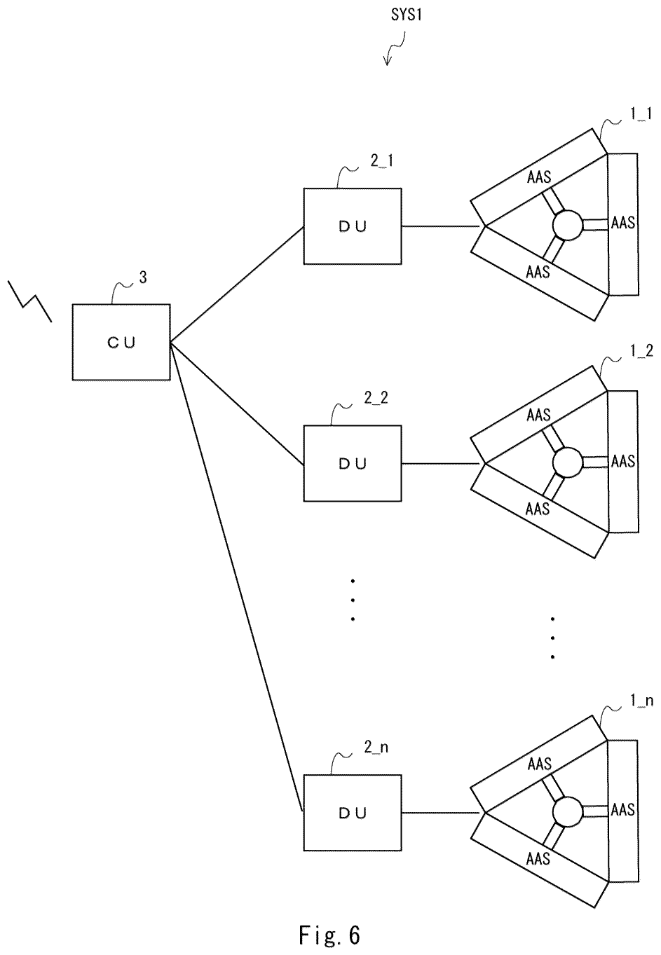

FIG. 6 shows a configuration example of a communication system SYS 1 to which the base station apparatus 1 is applied. As shown in FIG. 6, the communication system SYS 1 includes a CU 3, n DUs 2, and n base station apparatuses 1. The symbol n is a positive integer. The n DUs 2 are also referred to as DUs 2_1-2_n, and the n base station apparatuses 1 are also referred to as base station apparatuses 1_1-1_n. Each of the DUs 2 also serves as a management apparatus of the base station apparatus 1.

The CU 3 receives, for example, a 1 PPS signal from a GPS (GNSS) that is not shown. Based on this 1 PPS signal and a reference clock signal generated based on the 1 PPS signal, the DL/UL TDD timing from the DU 2_1 to each of the AASs 11-13 of the base station apparatus 1_1 is synchronized. Likewise, synchronization from the DUs 2_2-2_n to the base station apparatuses 1_2-1_n is also performed. The configurations and the operations of each of the base station apparatuses 1_1-1_n are similar to those of the base station apparatus 1. The base station apparatuses 1_1-1_n are arranged, for example, in an example of the arrangement as shown in FIG. 3. It is therefore possible to design station installation having no blind zones.

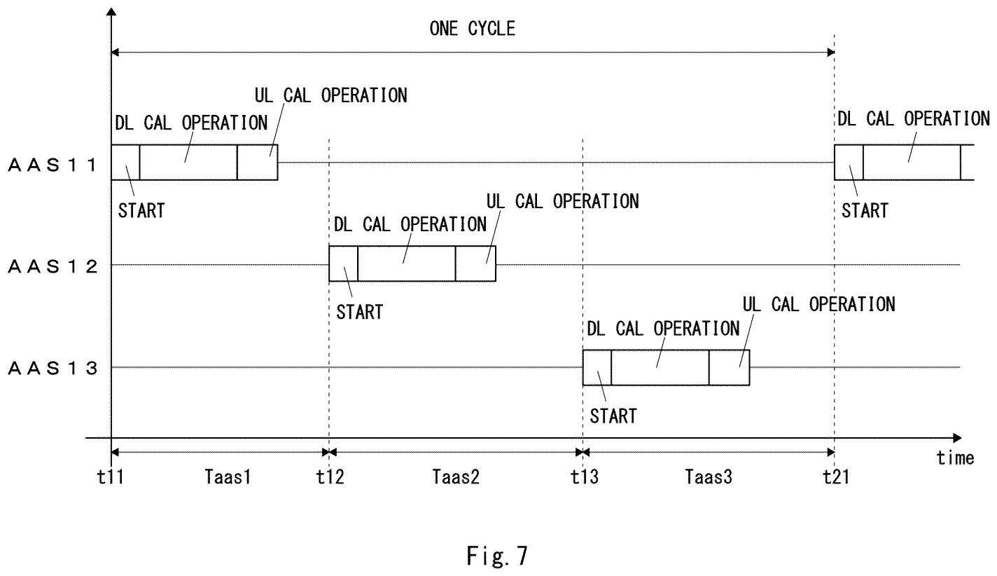

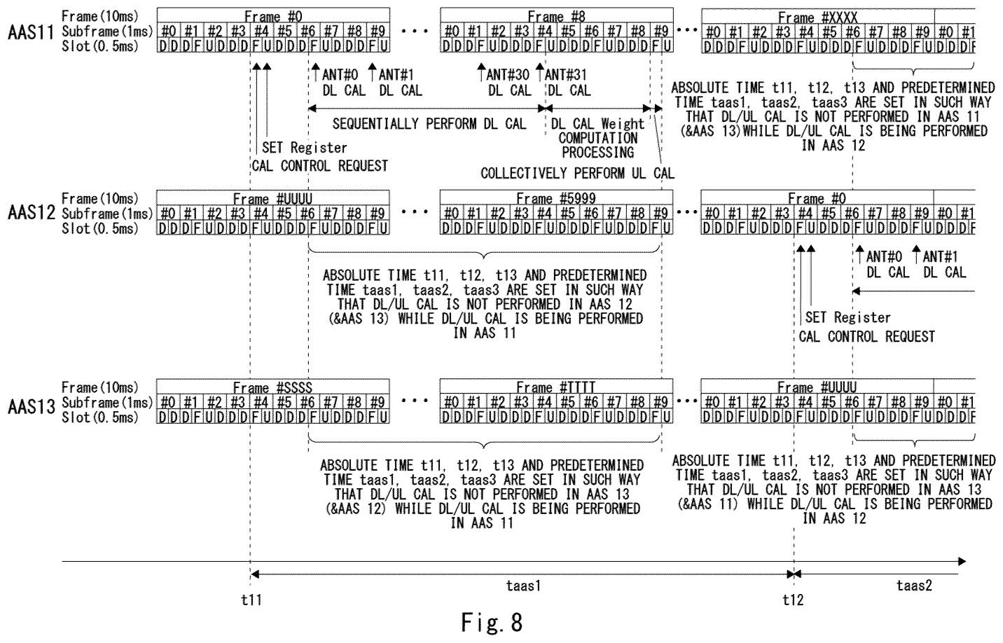

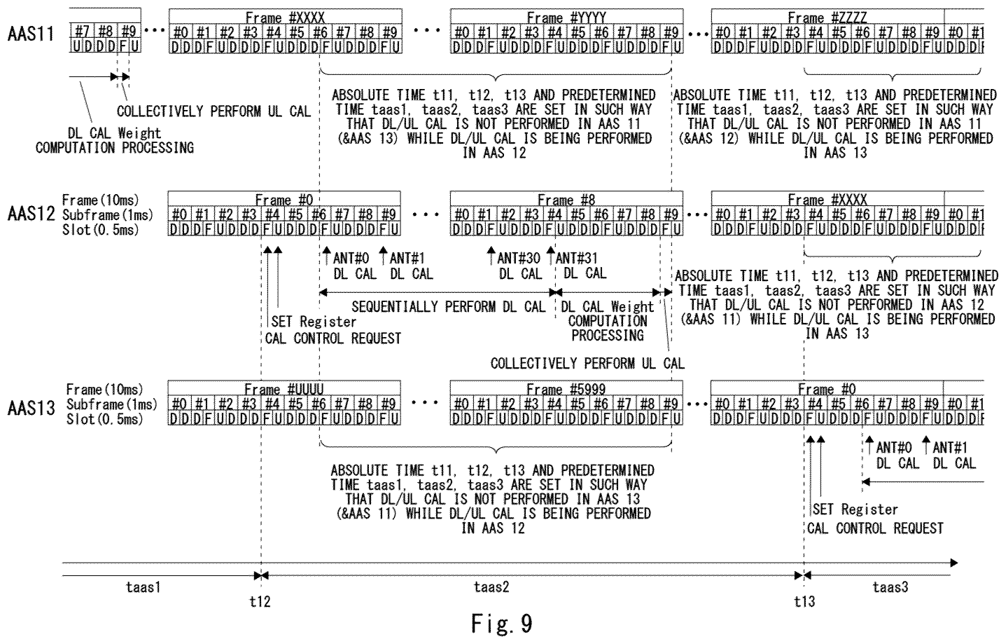

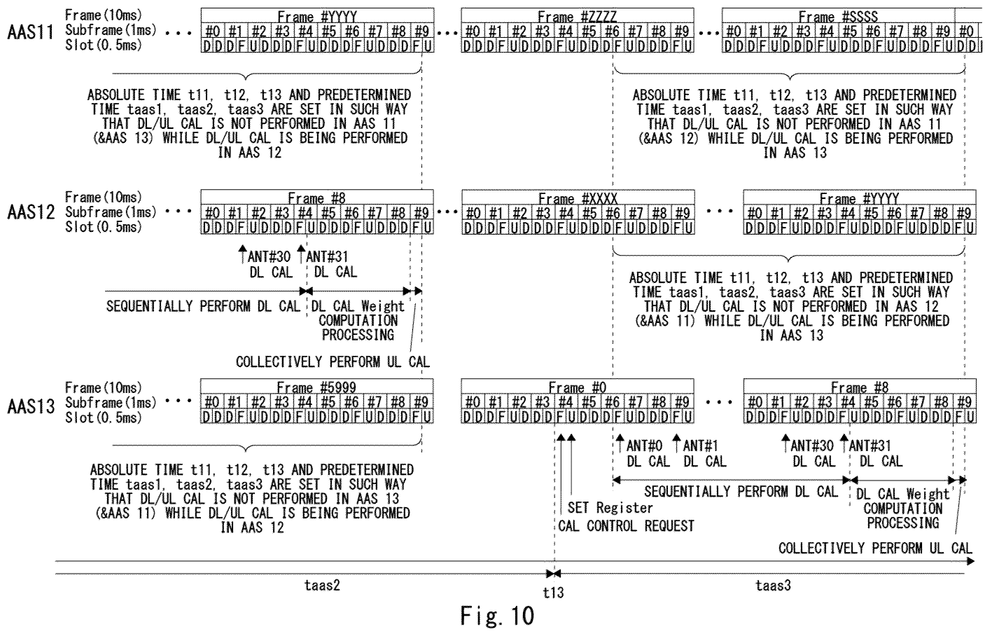

FIG. 7 is a timing chart showing an operation of the base station apparatus 1. Further, FIGS. 8-10 are timing charts showing further details of the operation of the base station apparatus 1. In the examples shown in FIGS. 7-10, DL/UL CAL of the AASs 11-13 is performed periodically with a cycle of one minute (=10 msec/Frame×6000 Frame).

Further, in the examples shown in FIGS. 8-10, 1 Frame of 10 msec is made up of 10 Subframes and 1 Subframe of 1 msec is made up of 2 Slots. 1 Slot of 0.5 msec is made up of 14 Symbols. Each Slot is one of a DL, a UL, or a Flexible Slot. In the examples shown in FIGS. 8-10, “D” indicates a DL Slot, “U” indicates a UL Slot, and “F” indicates a Flexible Slot. Further, in the examples shown in FIGS. 8-10, as a TDD DL/UL Configuration, DDDFU, which is employed in Japan and Germany, is employed, and DL/UL CAL is performed in a TX Off transient (10 microseconds) just after the DL Slot tail in the “F” slot of each DDDFU.

As already described above, in the base station apparatus 1 according to the present disclosure, each of the AASs 11-13 is configured to carry out DL CAL and UL CAL within a predetermined period from a predetermined time periodically set in accordance with the allocated unique ID. The unique ID, which is, for example, the number of the sector managed by the AASs 11-13, is sent from the DU to each of the AASs 11-13 via the optical fronthaul. Further, the predetermined time set in each of the AASs 11-13 is defined by a common time such as an absolute time sent from the DU to each of the AASs 11-13. The common time such as an absolute time is PTP-synchronized based on, for example, a 1 PPS signal that a higher-order apparatus such as RU has received from a GPS (GNSS) and a reference clock signal generated based on the 1 PPS signal.

Specifically, first, the AAS 11 carries out DL/UL CAL by a start-up instruction sent from Middleware to RF Software within a predetermined period Taas1 from the time t11 of the absolute time set in accordance with the sector number 1 allocated by the DU. Note that DL CAL is sequentially carried out by 32 transmitters that correspond to 32 antenna groups (64 antenna elements) installed in the AAS 11. Further, UL CAL is carried out collectively by 32 receivers after DL CAL is carried out.

After that, the AAS 12 carries out DL/UL CAL by a start-up instruction sent from Middleware to RF Software within a predetermined period Taas2 from the time t12 of the absolute time set in accordance with the sector number 2 allocated by the DU. Note that DL CAL is sequentially carried out by 32 transmitters that correspond to 32 antenna groups (64 antenna elements) installed in the AAS 12. Further, UL CAL is carried out collectively by 32 receivers after DL CAL is carried out. Here, the time t12 at which DL/UL CAL of the AAS 12 is performed is set in such a way that the time t12 becomes later than the time after an elapse of a predetermined period Taas1 from the time t11. Accordingly, DL/UL CAL of the AAS 11 and that of the AAS 12 no longer overlap each other, and therefore there is no interference of DL/UL CAL signals between the AASs 11 and 12.

Then, the AAS 13 carries out DL/UL CAL by a start-up instruction sent from Middleware to RF Software within a predetermined period Taas3 from the time t13 of the absolute time set in accordance with the sector number 3 allocated by the DU. Note that DL CAL is sequentially carried out by 32 transmitters that correspond to 32 antenna groups (64 antenna elements) installed in the AAS 13. Further, UL CAL is carried out collectively by 32 receivers after the DL CAL is carried out. Here, the time t13 at which DL/UL CAL of the AAS 13 is performed is set in such a way that the time t13 becomes later than the time after an elapse of a predetermined period Taas2 from the time t12. Accordingly, DL/UL CAL of the AAS 12 and that of the AAS 13 no longer overlap each other, and therefore there is no interference of DL/UL CAL signals between the AASs 12 and 13.

Further, the time after an elapse of the predetermined period Taas3 from the time t13 is set in such a way that this time becomes earlier than the elapsed time of the cycle of one minute in which DL/UL CAL of each of the AASs 11-13 is performed once. Therefore, even when DL/UL CAL of the AAS 11 is performed again in the next cycle, the DL/UL CAL of the AAS 13 and that of the AAS 11 do not overlap each other, whereby there is no interference of the DL/UL CAL signals between the AASs 13 and 11.

As described above, in the base station apparatus 1 according to the present disclosure, each of the AASs 11-13 performs DL/UL CAL according to a time in accordance with the unique ID, the time being defined by a common time, in such a way that this DL/UL CAL does not overlap the DL/UL CAL of another adjacent AAS. Accordingly, with the base station apparatus 1 according to the present disclosure, it is possible to prevent or reduce interference by DL CAL signals radiated and leaked outside the antennas of each of the AASs 11-13 with UL CAL signals of antennas of the AAS adjacent to the above AAS. For example, the delay error of UL CAL can be eliminated, the UL CAL time signal can be normalized, and the frequency spectrum of the UL CAL signal can be normalized. Accordingly, the base station apparatus 1 according to the present disclosure is able to prevent the accuracy of the DL/UL CAL of each of the AASs 11-13 from being degraded, thereby enabling high-quality communication.

While the case in which the base station apparatus 1 includes three AASs 11-13 has been described as an example in the present disclosure, this is merely one example. This configuration can be changed as appropriate to a configuration including two or more AASs.

Note that the time t11, t12, and t13 and the predetermined periods Taas1, Taas2, and Taas3 may be set in minutes or in seconds, or may be defined in the cycle of each Round Sequence. Further, the time t11, t12, and t13 and the predetermined periods Taas1, Taas2, and Taas3 are not limited to being defined by an absolute time and may instead be defined by a cycle of the frame number, the frequency of the CAL itself, or the like. For example, the start time of DL/UL CAL of the AAS 11 may be defined by the frame number. Alternatively, exclusive processing, such as not performing CAL processing in sectors other than the sector in which the CAL operation is performed, may be applied.

Further, it is expected that specification rules regarding the notification of the sector number sent from the DU to each of the AASs 11-13 of the base station apparatus 1 will be introduced into Open Radio Access Network (ORAN) standards. In this case, it is considered that a sector number can be presented to the AAS in each sector configuration via ORAN C-Plane control. Even in a system configuration in which DU and RU are not multi-vendor units that comply with the ORAN standards, if DU and RU are provided by the same vendor or an integrated apparatus, the base station apparatus 1 according to the present disclosure may be applied even when DU and RU do not comply with the ORAN standards.

One of great features of the present disclosure is that it is possible to increase the number of layers where a number of terminals can be simultaneously connected by Massive MIMO; that is, to increase the throughput, in a three-sector configuration of AASs with integrated super multi-element antennas for enabling Massive MIMO. Another great feature is that it is possible to avoid CAL performance degradation due to CAL signal interference and re-coupling between adjacent (or proximate) AASs in DL/UL CAL, which is required for the AASs to maximize the frequency utilization efficiency. Further, a great effect of the present disclosure is that it is possible to stably maximize the cell throughput in the three-sector configuration.

Further, it is important to reduce the size and the weight of the AAS for Massive MIMO in order to further expand the 5G area coverage rate, which is currently insufficient, and improve the stability of the communication quality regardless of the location while achieving high speed and high capacity in the Sub-6 GHz band having high-frequency usage efficiency. In addition, in order to cope with the shortage of station installation locations especially in urban areas where the demand for 5G traffic has been increasing, it is expected that there will be an increase in demands that the operation in the station installation locations be outsourced and transferred to tower companies, and that a high density of AASs for many different operators be installed at one station installation location, and it is also expected that there will be a greater demand for RAN Sharing by sharing AASs. In this case, the effect of the present disclosure, which is capable of avoiding spatial multiplexing performance degradation due to DL/UL CAL interference between adjacent (or proximate) AASs, is considered to be significantly great.

From the viewpoint of acceleration of 5G Stand Alone in place of LTE/4G toward B5G/6G starting from or around 2030, it is required to avoid DL/UL CAL interference between adjacent AASs to expand an area coverage in a high-density AAS arrangement and to improve the stability of communication quality of the present disclosure. Therefore the benefits of the present disclosure are considered to be significantly great.

(Configuration of Hardware that implements Communication Control Functions of Communication System SYS 1)

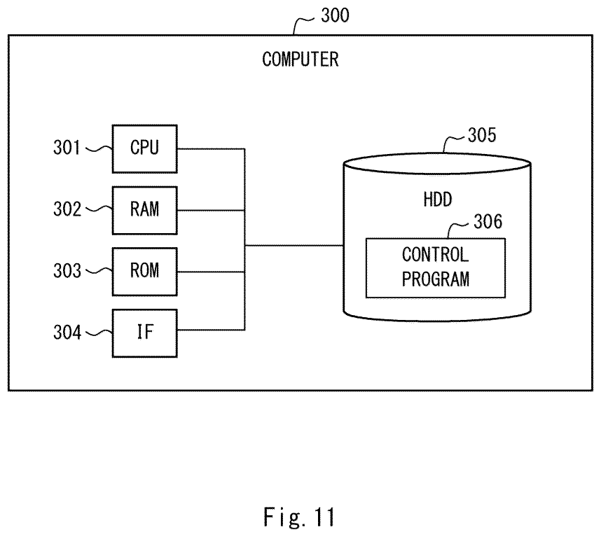

Some or all of communication control processing achieved by the communication system SYS 1 can be implemented by a general-purpose computer system. In other words, communication control processing achieved by the management apparatus (DU) 2 or the base station apparatus 1 in the communication system SYS 1 can be implemented by the general-purpose computer system. Hereinafter, with reference to FIG. 11, a brief description will be given.

FIG. 11 is a block diagram showing one example of a hardware configuration that implements some or all of the communication control functions of the communication system SYS 1. The computer 300 includes, for example, a Central Processing Unit (CPU) 301, which is a control apparatus, a Random Access Memory (RAM) 302, and a Read Only Memory (ROM) 303. The computer 300 further includes an Interface (IF) 304, which is an interface with an external device, and a Hard Disk Drive (HDD) 305, which is one example of a non-volatile storage apparatus. The computer 300 may further include, as components that are not shown, an input device such as a keyboard or a mouse, or a display device such as a display.

The HDD 305 stores an Operating System (OS) (not shown) and a control program 306. The control program 306 is a computer program with which the communication control processing of the communication system SYS 1 is implemented.

The CPU 301 controls various kinds of processing in the computer 300, and the access or the like to the RAM 302, the ROM 303, the IF 304, and the HDD 305. In the computer 300, the CPU 301 loads the OS or the control program 306 stored in the HDD 305 and executes the loaded OS or program. Accordingly, the computer 300 implements the communication control functions of the communication system SYS 1.

The above-described program includes instructions (or software codes) that, when loaded into a computer, cause the computer to perform one or more of the functions described in the embodiments. The program may be stored in a non-transitory computer readable medium or a tangible storage medium. By way of example, and not a limitation, computer readable media or tangible storage media can include a RAM, a ROM, a flash memory, a solid-state drive (SSD) or other types of memory technologies, a CD-ROM, a digital versatile disc (DVD), a Blu-ray (registered trademark) disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

While the present disclosure has been particularly shown and described with reference to example embodiments thereof, the present disclosure is not limited to these example embodiments. It will be understood by those of ordinary skill in the art that various changes in form and details may be made therein without departing from the sprit and scope of the present disclosure as defined by the claims. And each embodiment can be appropriately combined with at least one of embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

The whole or part of the example embodiments disclosed above can be described as, but not limited to, the following supplementary notes.

### (Supplementary Note 1)

A communication system comprising:
a base station apparatus comprising a plurality of Active Antenna Systems (AASs); and
a management apparatus configured to be able to communicate with each of the plurality of AASs, wherein
the management apparatus is configured to notify each of the plurality of AASs of a common time and an Identification (ID) that is unique to each of the plurality of respective AASs, and
each of the AASs is configured to perform downlink and uplink calibration within a predetermined period from a predetermined time that is defined by the common time and is periodically set in accordance with the ID allocated to each of the AASs.

### (Supplementary Note 2)

The communication system according to Supplementary Note 1, wherein each of the AASs sets the predetermined time and the predetermined period such that a time zone in which the downlink and uplink calibration is performed does not overlap a time zone in which calibration is performed by another AAS.

### (Supplementary Note 3)

The communication system according to Supplementary Note 1, wherein the base station apparatus comprises three AASs as the plurality of AASs.

### (Supplementary Note 4)

The communication system according to Supplementary Note 1, further comprising an optical fronthaul used for communication between each of the plurality of AASs and the management apparatus.

### (Supplementary Note 5)

A base station apparatus comprising:
a plurality of Active Antenna Systems (AASs),
wherein each of the AASs is configured to perform downlink and uplink calibration within a predetermined period from a predetermined time that is defined by a common time sent to the plurality of AASs and is periodically set in accordance with an ID allocated to each of the AASs.

### (Supplementary Note 6)

The base station apparatus according to Supplementary Note 5, wherein each of the AASs sets the predetermined time and the predetermined period such that a time zone in which the downlink and uplink calibration is performed does not overlap a time zone in which calibration is performed by another AAS.

### (Supplementary Note 7)

The base station apparatus according to Supplementary Note 5, comprising three AASs as the plurality of AASs.

### (Supplementary Note 8)

A method for controlling a communication system comprising:
a base station apparatus comprising a plurality of Active Antenna Systems (AASs); and
a management apparatus configured to be able to communicate with each of the plurality of AASs, wherein
the management apparatus notifies each of the plurality of AASs of a common time and an Identification (ID) that is unique to each of the plurality of respective AASs, and
in each of the AASs, downlink and uplink calibration is performed within a predetermined period from a predetermined time that is defined by the common time and is periodically set in accordance with the ID allocated to each of the AASs.

### (Supplementary Note 9)

The method for controlling the communication system according to Supplementary Note 8, wherein each of the AASs sets the predetermined time and the predetermined period such that a time zone in which the downlink and uplink calibration is performed does not overlap a time zone in which calibration is performed by another AAS.

### (Supplementary Note 10)

The method for controlling the communication system according to Supplementary Note 8, wherein the base station apparatus comprises three AASs as the plurality of AASs.

### (Supplementary Note 11)

A method for controlling a base station apparatus comprising a plurality of Active Antenna Systems (AASs), wherein, in each of the AASs, downlink and uplink calibration is performed within a predetermined period from a predetermined time that is defined by a common time sent to the plurality of AASs and is periodically set in accordance with a unique ID allocated to each of the AASs.

### (Supplementary Note 12)

A control program for causing a computer to execute control processing in a base station apparatus comprising a plurality of Active Antenna Systems (AASs), the control program causing a computer to execute processing for performing, in each of the AASs, downlink and uplink calibration within a predetermined period from a predetermined time that is defined by a common time sent to the plurality of AASs and is periodically set in accordance with a unique ID allocated to each of the AASs.

Note that some or all of the elements (e.g., the configurations and the functions) according to Supplementary Notes 2 to 4 that depend from Supplementary Note 1 may depend from Supplementary Notes 11 and 12 as well according to a dependency relationship similar to that in Supplementary Notes 2 to 4. Some or all of the elements according to any Supplementary Note may be applied to various kinds of hardware, software, recording means for recording software, system, and method.

According to the present disclosure, it is possible to provide a communication system, a base station apparatus, and a method for controlling the communication system capable of performing high-quality communication.

What is claimed is:

1. A communication system comprising:
a base station apparatus comprising a plurality of Active Antenna Systems (AASs); and
a management apparatus configured to be able to communicate with each of the plurality of AASs, wherein
the management apparatus is configured to notify each of the plurality of AASs of a common time and an Identification (ID) that is unique to each of the plurality of respective AASs, and
each of the AASs is configured to perform downlink and uplink calibration within a predetermined period from a predetermined time that is defined by the common time and is periodically set in accordance with the ID allocated to each of the AASs.

2. The communication system according to claim 1, wherein each of the AASs sets the predetermined time and the predetermined period such that a time zone in which the downlink and uplink calibration is performed does not overlap a time zone in which calibration is performed by another AAS.

3. The communication system according to claim 1, wherein the base station apparatus comprises three AASs as the plurality of AASs.

4. The communication system according to claim 1, further comprising an optical fronthaul used for communication between each of the plurality of AASs and the management apparatus.

5. A base station apparatus comprising:
a plurality of Active Antenna Systems (AASs),
wherein each of the AASs is configured to perform downlink and uplink calibration within a predetermined period from a predetermined time that is defined by a common time sent to the plurality of AASs and is periodically set in accordance with an ID allocated to each of the AASs.

6. The base station apparatus according to claim 5, wherein each of the AASs sets the predetermined time and the predetermined period such that a time zone in which the downlink and uplink calibration is performed does not overlap a time zone in which calibration is performed by another AAS.

7. The base station apparatus according to claim 5, comprising three AASs as the plurality of AASs.

8. A method for controlling a communication system comprising:
a base station apparatus comprising a plurality of Active Antenna Systems (AASs); and
a management apparatus configured to be able to communicate with each of the plurality of AASs, wherein
the management apparatus notifies each of the plurality of AASs of a common time and an Identification (ID) that is unique to each of the plurality of respective AASs, and
in each of the AASs, downlink and uplink calibration is performed within a predetermined period from a predetermined time that is defined by the common time and is periodically set in accordance with the ID allocated to each of the AASs.

9. The method for controlling the communication system according to claim 8, wherein each of the AASs sets the predetermined time and the predetermined period such that a time zone in which the downlink and uplink calibration is performed does not overlap a time zone in which calibration is performed by another AAS.

10. The method for controlling the communication system according to claim 8, wherein the base station apparatus comprises three AASs as the plurality of AASs.
